(19) United States
(12) Patent Application Publication
(10) Pub. No.: US 2013/0095386 A1
(43) Pub. Date: Apr. 18, 2013

(54) Metal Fluoride Electrode Protection Layer and Method of Making Same

(71) Applicants: Wu Xu, Richland, WA (US); Wei Wang, Kennewick, WA (US); Zhenguo Yang, Richland, WA (US); Jiguang Zhang, Richland, WA (US); Daiwon Choi, Richland, WA (US)

(72) Inventors: Wu Xu, Richland, WA (US); Wei Wang, Kennewick, WA (US); Zhenguo Yang, Richland, WA (US); Jiguang Zhang, Richland, WA (US); Daiwon Choi, Richland, WA (US)

(73) Assignee: BATTELLE MEMORIAL INSTITUTE, Richland, WA (US)

(21) Appl. No.: 13/271,931

(22) Filed: Oct. 12, 2011

(51) Int. Cl. H01M 4/485; H01M 4/583; H01M 4/38; B82Y 30/00

(52) U.S. Cl. 429/231.1; 429/218.1; 429/231.5; 429/231.8; 977/755

(57) ABSTRACT

Modifications to the surface of an electrode and/or the surfaces of the electrode material can improve battery performance. For example, the modifications can improve the capacity, rate capability and long cycle stability of the electrode and/or may minimize undesirable catalytic effects. In one instance, metal-ion batteries can have an anode that is coated, at least in part, with a metal fluoride protection layer. The protection layer is preferably less than 100 nm in thickness.

### STATEMENT REGARDING FEDERALLY SPONSORED RESEARCH OR DEVELOPMENT

This invention was made with Government support under Contract DE-AC0576RLO1830 awarded by the U.S. Department of Energy. The Government has certain rights in the invention.

### BACKGROUND

Metal ion batteries are increasingly considered to be the most suitable energy systems for applications ranging from electric vehicles to stationary energy storage. However, many challenges must be addressed before metal ion batteries can be utilized to their full potential. For example, carbonaceous materials are commonly used in lithium-ion batteries, especially graphite, as the anode in the full cell configuration, which can cause the formation of a solid electrolyte interface (SEI) layer on the carbon surface due to the reductive decompositions of solvent molecules and lithium salt. While this SEI layer is critical to carbon anode-based lithium-ion batteries, the resistance of this SEI layer increases continuously with cycling and at higher temperatures because of the increase of the SEI thickness. The increased resistance can result in a reduction of the cycle life and calendar life of the batteries and an increase in heat generation during high rate cycling. At the same time, the instability of the SEI layer at high temperatures can initiate thermal runaway of lithium-ion batteries and cause serious safety problems. The formation of the SEI layer makes it difficult for the lithium ions to intercalate into the graphite anode at low temperatures, which significantly reduces the energy and power output during low temperature usage.

Alternative anode materials such as titanium oxide based materials (e.g., TiO₂ spinel Li₄Ti₅O₁₂, and others) exist, but present different challenges. For example, Li₄Ti₅O₁₂ is often seen as one of the most promising anode materials for large-scale lithium-ion batteries because it has negligible volume change, high thermal stability, and flat potential around 1.55 V vs. Li/Li⁺ during charge and discharge. Excellent cycle life and high temperature performance could be achieved even at elevated temperatures. Because its intercalation/de-intercalation voltage (1.55 V) is higher than the reductive decomposition voltages of organic carbonate solvents (normally around 0.9˜1.1 V), no SEI layer is formed on the spinel Li₄Ti₅O₁₂ surface and the formation of metallic lithium is sufficiently avoided. Thus, safer batteries can be achieved.

However, the very low electronic conductivities of spinel Li₄Ti₅O₁₂ and TiO₂ arising from the empty Ti 3d state with band energy of about 2 eV can result in poor rate capability and power performance. Furthermore, due to the catalytic effect of titanium, organic solvents and trace water in the electrolytes can decompose into gases during long term storage in the charged state, especially at high temperatures. Serious gassing and swelling problems have been observed, especially if the battery package material contains aluminum and/or aluminum-laminated polymers.

Accordingly, a need for improvements in metal-ion batteries exists, especially those improvements that address at least some of the electrode problems described above and elsewhere herein.

### SUMMARY

Embodiments of the present invention encompass surface modification of anodes in metal-ion batteries and electrodes in sodium-ion batteries. The surface modifications improve the stability of the electrode materials against reactants in the electrolyte, such as Lewis acids and, in a particular example, HF generated from LiPF₆— the lithium salt in state-of-the-art lithium ion battery electrolytes. Furthermore, the modifications can inhibit undesirable catalytic effects associated with the electrode materials, especially titanium oxide based materials. Further still, the modifications described herein can result in coordination between surface anions and other anions to form a new solid anion. Therefore, the electronic and/or ionic conductivities can be improved compared with unmodified surfaces.

In one embodiment, the metal-ion battery anode can comprise an anode material coated, with a protection layer comprising a metal fluoride. Preferably, the metal fluoride comprises aluminum fluoride. In preferred embodiments, the protection layer can be between 0.01 wt % and 10 wt % of the anode.

The anode material can comprise titanium oxide-based materials. Examples include, but are not limited to, TiO₂ and Li₄Ti₅O₁₂. Alternatively, the anode material can comprise carbon, silicon, silicon oxide, tin, tin oxide, antimony, or combinations thereof.

The metal ion can comprise lithium ion or sodium ion. For sodium ion batteries, the cathode can also be coated with a layer comprising metal fluoride. For example, a particular embodiment of the present invention encompasses a lithium-ion battery having an anode comprising a titanium oxide-based material coated, with a protection layer comprising AlF₃. The protection layer has a thickness less than 100 nm. Alternatively, embodiments of the present invention can encompass an electrode in a sodium-ion battery. The electrode comprises a material coated at least in part, with a protection layer comprising metal fluoride. The protection layer has a thickness less than 100 nm. The metal fluoride can comprise aluminum fluoride.

While the protection layer can be a layer covering the surface of the electrode, in preferred embodiments, the protection layer coats the surfaces of electrode material composing the electrode. For example, in electrodes fabricated from a powder source, the protection layer can be a layer coating, at least in part, the resultant aggregated particles composing the electrode.

The purpose of the foregoing abstract is to enable the United States Patent and Trademark Office and the public generally, especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

Various advantages and novel features of the present invention are described herein and will become further readily apparent to those skilled in this art from the following detailed description. In the preceding and following descriptions, the various embodiments, including the preferred embodiments, have been shown and described. Included herein is a description of the best mode contemplated for carrying out the invention. As will be realized, the invention is capable of modification in various respects without departing from the invention. Accordingly, the drawings and description of the preferred embodiments set forth hereafter are to be regarded as illustrative in nature, and not as restrictive.

### DESCRIPTION OF DRAWINGS

Embodiments of the invention are described below with reference to the following accompanying drawings.

FIG. 1 contains X-ray diffraction (XRD) patterns of various aluminum fluoride coated powders comprising Li₄Ti₅O₁₂ powders according to embodiments of the present invention.

FIG. 2 is a TEM micrograph of one embodiment of a 5% AlF₃-coated Li₄Ti₅O₁₂ particle.

FIG. 3 compares the first cycle discharge (Li⁺ insertion) and charge (Li⁺ de-insertion) profiles of AlF₃-coated and uncoated Li₄Ti₅O₁₂ materials in half cells in the voltage range from 1.0 to 2.5 V at C/10 rate.

FIG. 4 shows the rate capability (a) and the long term cycling performance (b) at room temperature of AlF₃-coated LTO materials compared with uncoated LTO.

FIG. 5 shows the rate capability (a) and the long term cycling performance (b) at 55° C. of AlF₃-coated LTO materials compared with uncoated LTO.

FIG. 6 shows the rate and cycling performance at room temperature of AlF₃-coated graphite carbon in half cells in the voltage range from 0.01 to 1.2 V.

### DETAILED DESCRIPTION

The following description includes the preferred best mode of one embodiment of the present invention. It will be clear from this description of the invention that the invention is not limited to these illustrated embodiments but that the invention also includes a variety of modifications and embodiments thereto. Therefore the present description should be seen as illustrative and not limiting. While the invention is susceptible of various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

In one embodiment of the present invention, an aluminum fluoride coated Li₄Ti₅O₁₂ material was prepared and characterized. AlF₃-coated Li₄Ti₅O₁₂ materials with varying AlF₃ content were prepared using Li₄Ti₅O₁₂ (nanopowder, 22-nm particle size, >98% trace metal basis), aluminum nitrate nonahydrate (Al(NO₃)₃.9H₂O, 98+%), ammonium fluoride (NH₄F, 98+%), and 1-methyl-2-pyrrolidinone (NMP, spectrophotometric grade, 99+%). Super P® (Timcal) carbon black and polyvinylidene fluoride (PVDF), lithium foil (99.9%, 0.75-mm thick), copper foil (18-μm thick, with one side roughened, battery grade), lithium hexafluorophosphate (LiPF₆), ethylene carbonate (EC), and dimethyl carbonate (DMC) were used to prepare an electrodes and fabricate a coin cell.

AlF₃-coated Li₄Ti₅O₁₂ powders with different AlF₃ contents were prepared as below. Li₄Ti₅O₁₂ powders were immersed in deionized water and magnetically stirred with a stirring bar. Aluminum nitrate nonahydrate was added into the above suspension and continued to stir for half an hour at room temperature. Then a solution comprising a stoichoimetric amount of ammonium fluoride in deionized water was slowly added. The molar ratio of Al to F was fixed to 3. After that, the whole mixture was continuously stirred, slowly heated to 80° C. in an oil bath and maintained at this temperature for 5 hours. After cooling, the solid powders were filtered, washed thoroughly with deionized water, dried in air, and then calcined in a tube furnace at 400° C. for 5 hours with the continuous flowing of pure argon or nitrogen to avoid the formation of Al₂O₃. After cooling, the obtained powders were AlF₃-coated Li₄Ti₅O₁₂ and are abbreviated herein as xAFLTO, where x is the weight percentage of AlF₃ based on the weight of Li₄Ti₅O₁₂ (LTO) during synthesis. For instance, 2AFLTO means 2% AlF₃ based on LTO weight. Powders having 1%, 2%, 3% and 5% AlF₃ coatings on LTO particles were prepared.

The xAFLTO powders and resultant anodes were characterized using X-ray diffraction (XRD) and transmission electron microscopy (TEM). XRD was measured on a Philips Xpert X-ray diffractometer with Cu Kα radiation at λ1.54 Å, from 10° to 80° at a scanning rate of 0.02° per 10 sec. The samples for TEM were prepared by dusting the powder particles on 200 mesh TEM grid which minimized any artificial change to the samples. High resolution TEM analysis was carried out on a Jeol JEM 2010 microscope fitted with an LaB₆ filament and an acceleration voltage of 200 kV. The point-to-point resolution of the microscope is 0.194 nm. Elemental composition of the sample was analyzed using energy dispersive x-ray spectroscopy (EDS) that attached to the microscope.

The xAFLTO powders were mixed with SP and PVDF-NMP solutions at a weight ratio of 8:1:1 for xAFLTO/SP/PVDF. The slurry was well mixed using a PRO250 Homogenizer® (PRO Scientific Inc.) and coated on the rough side of the copper foil. After the solvent NMP was evaporated completely inside a fume hood, the electrode sheet was pressed at 1000 psi for 1 minute on a hydraulic unit and then punched into disks having a diameter of 1.43 cm and an area of 1.60 cm². The disks were dried at 80° C. under high vacuum overnight before use. For comparison, a control electrode comprising LTO/SP/PVDF at 8:1:1 by weight was also prepared in the same manner without a protection layer coating.

Coin-cell-type half cells of 2325 size were assembled inside a glove box. The cells were constructed by placing in sequence an xAFLTO electrode disk on the cell pan, one piece of polypropylene separator (2.06-cm diameter, Celgard 3501), a 100-1 μL electrolyte (1.0M LiPF₆ in EC-DMC at a 1:2 volume ratio), a 1.59-cm-diameter lithium disk, a 0.5-mm-thick stainless steel spacer and a wave spring, and finishing with a coin cell cover with a polypropylene gasket. The whole assembly was crimped at a gas pressure of 200 psi on a pneumatic coin cell crimper.

The cycling performance of the xAFLTO coin-cell batteries was tested at room temperature and at 55° C. on an Arbin battery tester (BT-2000) between 1.0 and 2.5 V vs. Li/Li⁺. All cells were first conducted one formation cycle at C/10 rate where 1C was 175 mAh and then cycled at different charge/discharge rates. For high temperature cycling, the cells were kept inside a controlled-environment chamber.

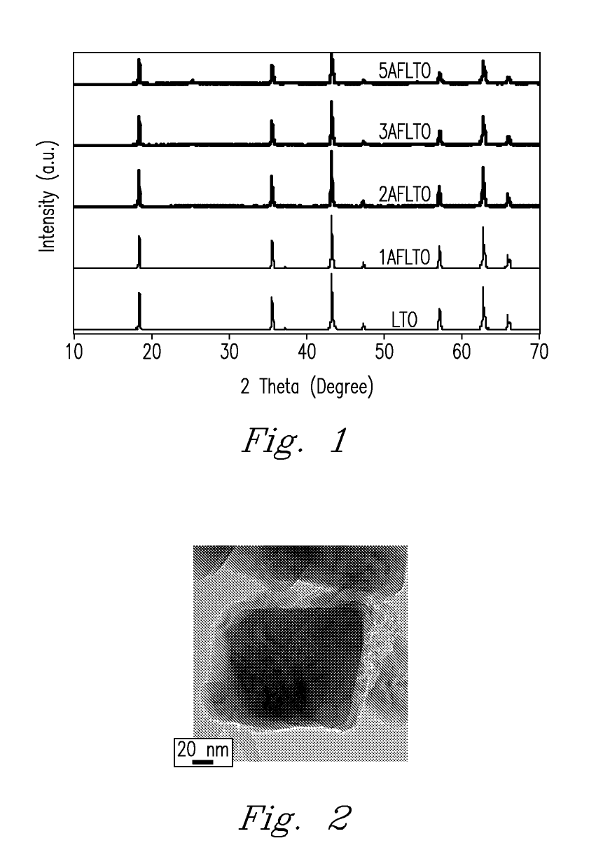

Referring to FIG. 1, XRD patterns of the AlF₃-coated Li₄Ti₅O₁₂ powders at different AlF₃-coating contents and of uncoated LTO are compared. All xAFLTO samples show the same strong characteristic peaks as LTO. When x 2, the xAFLTO samples also show an extra peak at 25° for AlF₃ (XRD pattern of 01-080-1007). The intensity of this peak increases with the increase of AlF₃-coating amount. However, this peak is not seen in the 1 AFLTO sample probably because the 1% AlF₃-coating is too small to be detected. It is demonstrated that the coating of AlF₃ does not change the crystalline structure of LTO.

FIG. 2 is a TEM micrograph of a 5% AlF₃-coated LTO particle. The AlF₃-coating layer is clearly observed with a thickness of about 15 nm. Similar results (not shown) were observed in samples having various AlF₃-coating contents, wherein the coating thickness depended on AlF₃ content. As is shown in FIG. 2, in preferred embodiments, the protection layer coats the particles and/or aggregates of the electrode material. In other embodiments, the protection layer can coat, at least in part, a surface of the electrode itself.

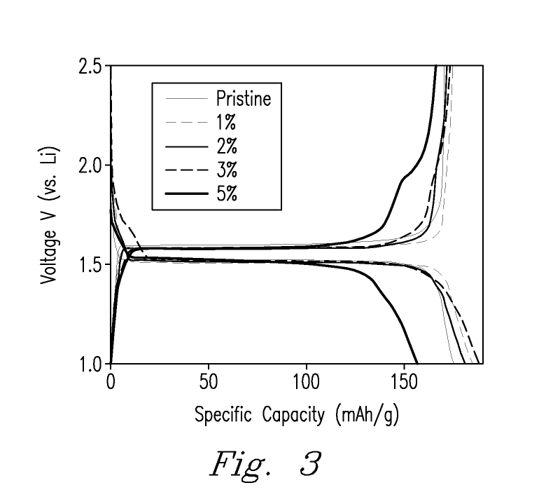

FIG. 3 compares the first cycle discharge (Li⁺ insertion) and charge (Li⁺ de-insertion) profiles of AlF₃-coated and uncoated LTO materials in half cells in the voltage range from 1.0 to 2.5 Vat C/10 rate.

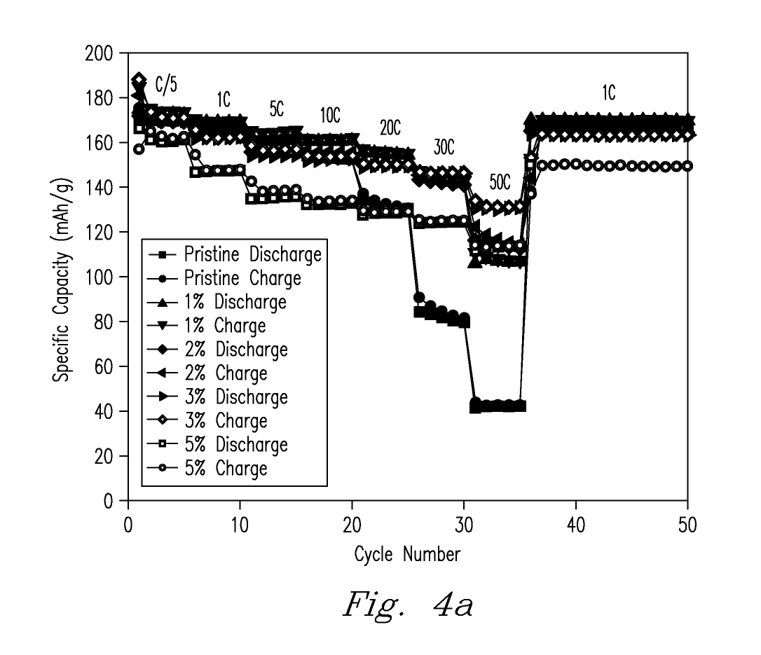

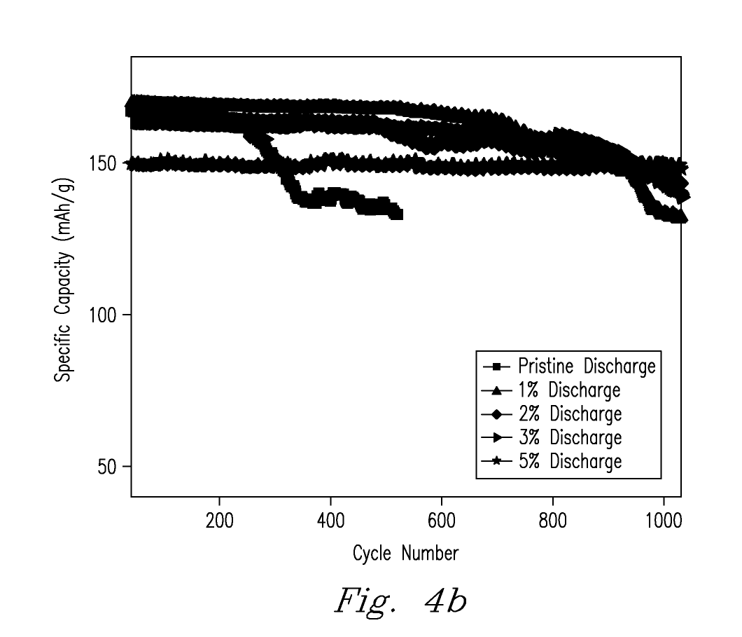

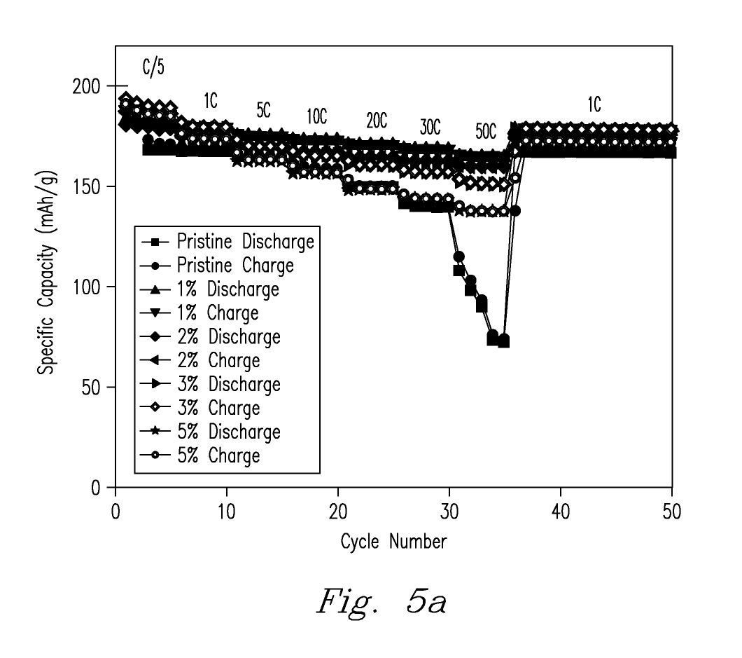

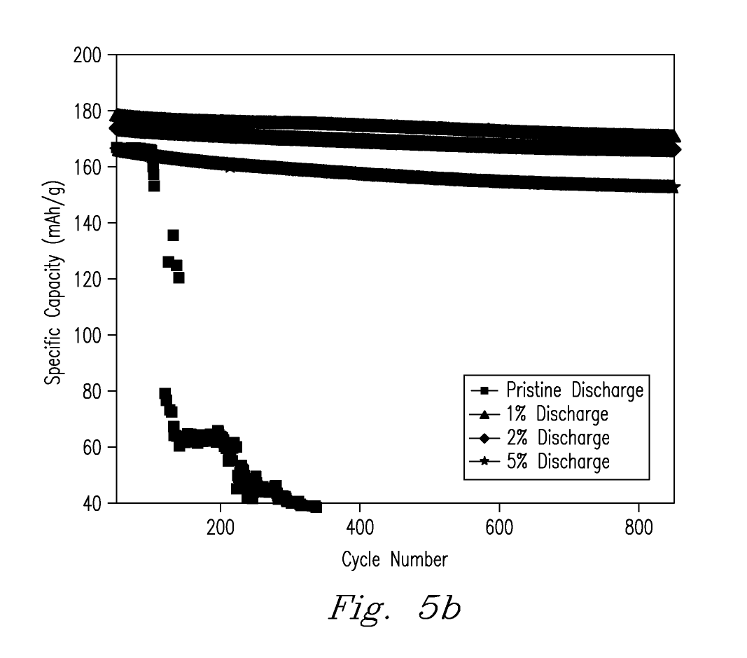

(FIG. 4 shows the rate capability (a) and the long term cycling performance (b) at room temperature of AlF₃-coated LTO materials compared with uncoated LTO. FIG. 5 shows the rate capability (a) and the long term cycling performance (b) at 55° C. of AlF₃-coated LTO materials compared with uncoated LTO. It is clearly seen that the coating of less than 5% AlF₃ on LTO significantly improves the discharge capacity at high rates and the long cycle life especially at high temperatures.

In another embodiment of the present invention, aluminum fluoride coated graphite carbon materials with varying AlF₃ content were prepared and tested. The preparation procedure was the same as AlF₃-coated Li₄Ti₅O₁₂ materials but just using graphite (Conoco-Phillip CGP-G8) to replace Li₄Ti₅O₁₂. The obtained AlF₃-coated graphite powders are abbreviated herein as xAFC, where x is the weight percentage of AlF₃ based on the weight of graphite during synthesis. For instance, 2AFC means 2% AlF₃ based on graphite weight. Powders having 0.5%, 1% and 2% AlF₃ coatings on graphite particles were prepared.

The xAFC/SP/PVDF electrodes at a weight ratio of 8:1:1 were prepared using the same procedures for xAFLTO/SP/PVDF electrodes, but were punched into disks having a diameter of 1.27 cm and an area of 1.27 cm². Coin-cell-type half cells of 2032 size were assembled inside a glove box. The cells were constructed by placing in sequence an xAFC electrode disk on the cell pan, one piece of polypropylene separator (1.90-cm diameter, Celgard 2500), an 80-μL electrolyte (1.0M LiPF₆ in EC-EMC at a 3:7 volume ratio), a 1.43-cm-diameter lithium disk, a 0.5-mm-thick stainless steel spacer and a wave spring, and finishing with a coin cell cover with a polypropylene gasket. The whole assembly was crimped at a gas pressure of 200 psi on a pneumatic coin cell crimper.

The cycling performance of the xAFC coin-cell batteries was tested at room temperature on an Arbin battery tester (BT-2000) between 0.01 and 1.2 V vs. Li/Li⁺. All cells were first conducted two formation cycles at C/20 rate where 1C was 372 mAh and then cycled at different charge/discharge rates.

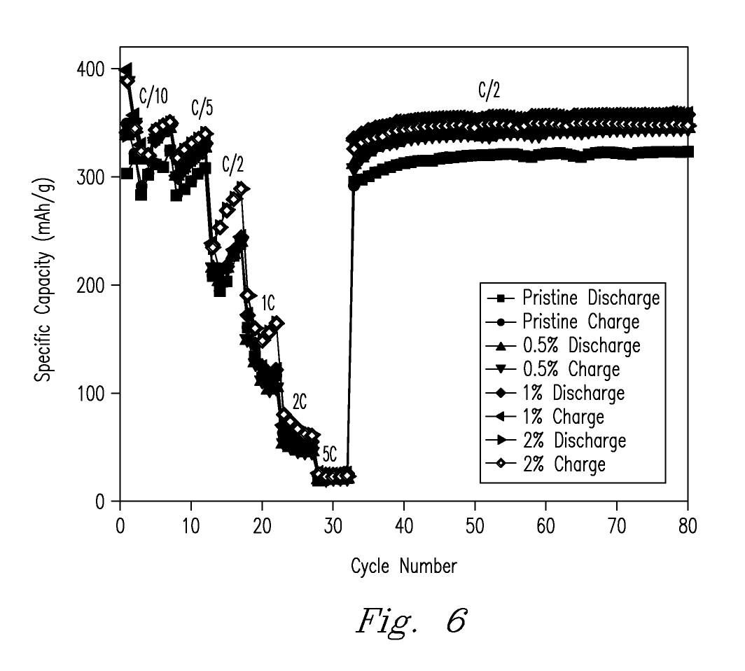

FIG. 6 shows the rate capability and cycling performance at room temperature of AlF₃-coated graphite materials compared with uncoated graphite. It is seen that the coating of 0.5% AlF₃ on graphite improves the discharge capacity at high rates. The capacity and capacity retention of the graphite are also enhanced by coating of AlF₃ up to 2% or more.

Although AlF₃ itself is a semi-conductive material, it can coordinate another anion to form a new solid anion due to the electron-deficiency characteristic of aluminum atom in AlF₃. Anions with which AlF₃ can coordinate can be found, for example, on the electrode material or in the electrolyte. Therefore the electronic and ionic conductivities of this AlF₃ coating layer can be significantly improved compared to that which might normally be expected. Excellent high power performance is achieved.

AlF₃ is quite stable against HF and other Lewis acids generated from the reactions of the electrolytic solute LiPF₆ with residual water and organic solvents or from the thermal decomposition of LiPF₆ at elevated temperatures. The dissolution loss of titanium from the active material caused by the corrosion from the generated HF and other acidic species can be prevented, which results in high capacity and excellent capacity retention with long cycle life especially at elevated temperatures. Furthermore, due to the relatively inert properties of AlF₃, the catalytic effect of Li₄Ti₅O₁₂ or TiO₂ is significantly reduced or even prevented by the AlF₃ layer. Therefore, the gassing problem of the lithium-ion batteries during long term storage in the charged state could be delayed.

While a number of embodiments of the present invention have been shown and described, it will be apparent to those skilled in the art that many changes and modifications may be made without departing from the invention in its broader aspects. The appended claims, therefore, are intended to cover all such changes and modifications as they fall within the true spirit and scope of the invention.

We claim:

1. A metal-ion battery having an anode, the anode characterized by an anode material coated, at least in part, with a protection layer comprising a metal fluoride, the protection layer having a thickness less than 100 nm.

2. The metal-ion battery of claim 1, wherein the metal fluoride comprises aluminum fluoride.

3. The metal-ion battery of claim 1, wherein the anode material comprises a titanium oxide-based material.

4. The metal-ion battery of claim 3, wherein the titanium oxide-based material comprises TiO₂.

5. The metal-ion battery of claim 3, wherein the titanium oxide-based material comprises Li₄Ti₅O₁₂.

6. The metal-ion battery of claim 1, wherein the anode material comprises carbon.

7. The metal-ion battery of claim 1, wherein the anode material comprises silicon or silicon oxide.

8. The metal-ion battery of claim 1, wherein the anode material comprises tin or tin oxide.

9. The metal-ion battery of claim 1, wherein the anode material comprises antimony.

10. The metal-ion battery of claim 1, wherein the metal-ion comprises lithium ion.

11. The metal-ion battery of claim 1, wherein the metal-ion comprises sodium ion.

12. The metal-ion battery of claim 11, further comprising a cathode coated, at least in part, with a layer comprising metal fluoride.

13. The metal-ion battery of claim 1, wherein the protection layer is between 0.01 wt % and 10 wt % of the anode.

14. The metal-ion battery of claim 1, wherein the metal fluoride is coordinated with another anion.

15. A lithium-ion battery having an anode, the anode characterized by a titanium oxide based material coated, at least in part, with a protection layer comprising AlF₃, the protection layer having a thickness less than 100 nm.

16. An electrode in a sodium-ion battery, the electrode characterized by an electrode material coated, at least in part, with a protection layer comprising metal fluoride, the protection layer having a thickness less than 100 nm.

17. The electrode of claim 17, wherein the metal fluoride comprises aluminum fluoride.
